(19) United States
(12) Patent Application Publication
(10) Pub. No.: US 2026/0190021 A1
(43) Pub. Date: Jul. 2, 2026

(54) METHOD FOR TRANSMITTING/RECEIVING UPLINK SIGNAL AND APPARATUS FOR SAME

(71) Applicant: LG Electronics Inc., Seoul (KR)

(72) Inventors: Seonwook KIM, Seoul (KR); Kijun KIM, Seoul (KR); Suckchel YANG, Seoul (KR); Seunghwan CHOI, Seoul (KR); Haewook PARK, Seoul (KR); Kyuseok KIM, Seoul (KR); Seongwon GO, Seoul (KR)

(21) Appl. No.: 18/859,074

(22) PCT Filed: Apr. 6, 2023
(86) PCT No.: PCT/KR2023/004651

§ 371 Date: Oct. 22, 2024

(30) Foreign Application Priority Data
Apr. 22, 2022 (KR) 10-2022-0050044
Aug. 10, 2022 (KR) 10-2022-0100224

(51) Int. Cl. H04W 52/02; H04L 5/00; H04W 72/23

(52) U.S. Cl. CPC H04W 52/0206; H04L 5/0094; H04W 72/23

(57) ABSTRACT

The present disclosure provides a method by which a terminal transmits a sounding reference signal (SRS) in a wireless communication system. In particular, the method may comprise: receiving (i) first information related to a plurality of SRS resource sets and (ii) second information related to SRS groups corresponding to the respective plurality of SRS resource sets, wherein each of the plurality of SRS resource sets includes at least one SRS resource; receiving third information indicating that, among the SRS groups, a first SRS group is available and a second SRS group is not available; and transmitting an SRS through an SRS resource of an SRS resource set included in the first SRS group, wherein all of one or more first SRS resource sets included in the first SRS group correspond to the number of first antenna ports, all of one or more second SRS resource sets included in the second SRS group correspond to the number of second antenna ports, and the number of first antenna ports and the number of second antenna ports are different.

### TECHNICAL FIELD

The disclosure relates to a method and apparatus for transmitting and receiving an uplink (UL) signal, and more particularly, to a method and apparatus for transmitting and receiving a UL signal to induce an effect of reducing power consumption of a base station (BS) by adjusting a reception antenna of the BS based on a configuration related to a sounding reference signal (SRS) resource or SRS resource set.

### BACKGROUND

As more and more communication devices demand larger communication traffic along with the current trends, a future-generation 5^{th} generation (5G) system is required to provide an enhanced wireless broadband communication, compared to the legacy LTE system. In the future-generation 5G system, communication scenarios are divided into enhanced mobile broadband (eMBB), ultra-reliability and low-latency communication (URLLC), massive machine-type communication (mMTC), and so on.

Herein, eMBB is a future-generation mobile communication scenario characterized by high spectral efficiency, high user experienced data rate, and high peak data rate, URLLC is a future-generation mobile communication scenario characterized by ultra-high reliability, ultra-low latency, and ultra-high availability (e.g., vehicle to everything (V2X), emergency service, and remote control), and mMTC is a future-generation mobile communication scenario characterized by low cost, low energy, short packet, and massive connectivity (e.g., Internet of things (IOT)).

### DISCLOSURE

### Technical Problem

An object of the disclosure is to provide a method of transmitting and receiving uplink signals and an apparatus therefor.

It will be appreciated by persons skilled in the art that the objects that could be achieved with the disclosure are not limited to what has been particularly described hereinabove and the above and other objects that the disclosure could achieve will be more clearly understood from the following detailed description.

### Technical Solution

A method of transmitting a sounding reference signal (SRS) by a user equipment (UE) in a wireless communication system according to an embodiment of the disclosure may includes receiving (i) first information related to a plurality of SRS resource sets and (ii) second information related to an SRS group corresponding to each of the plurality of SRS resource sets, wherein each of the plurality of SRS resource sets includes at least one SRS resource, receiving third information indicating that a first SRS group is available and a second SRS group is not available among the SRS groups, and transmitting an SRS in an SRS resource of an SRS resource set included in the first SRS group. All of at least one first SRS resource set included in the first SRS group may correspond to a first number of antenna ports, and all of at least one second SRS resource set included in the second SRS group may correspond to a second number of antenna ports. The first number of antenna ports and the second number of antenna ports may be different.

The SRS may not be transmitted in an SRS resource of an SRS resource set corresponding to an SRS group of a second index.

Further, a first physical uplink shared channel (PUSCH) or a second physical uplink control channel (PUCCH) associated with an SRS resource set corresponding to the first SRS group may be transmitted, and a second PUSCH or a second PUCCH associated with an SRS resource set corresponding to the second SRS group may not be transmitted.

Further, an SRS request field may be received and differently interpreted based on the third information.

Further, the SRS may be transmitted after a specific time from a reception time of the third information.

Further, the third information may be included in downlink control information (DCI) or a medium access control control element (MAC CE).

A UE for transmitting an SRS in a wireless communication system according to the disclosure may include at least one transceiver, at least one processor, and at least one memory operably connected to the at least one processor and storing instructions which when executed, cause the at least one processor to perform operations. The operations may include receiving (i) first information related to a plurality of SRS resource sets and (ii) second information related to an SRS group corresponding to each of the plurality of SRS resource sets through the at least one transceiver, wherein each of the plurality of SRS resource sets includes at least one SRS resource, receiving third information indicating that a first SRS group is available and a second SRS group is not available among the SRS groups through the at least one transceiver, and transmitting an SRS in an SRS resource of an SRS resource set included in the first SRS group through the at least one transceiver. All of at least one first SRS resource set included in the first SRS group may correspond to a first number of antenna ports, and all of at least one second SRS resource set included in the second SRS group may correspond to a second number of antenna ports. The first number of antenna ports and the second number of antenna ports may be different.

The SRS may not be transmitted in an SRS resource of an SRS resource set corresponding to an SRS group of a second index.

Further, a first PUSCH or a second PUCCH associated with an SRS resource set corresponding to the first SRS group may be transmitted, and a second PUSCH or a second PUCCH associated with an SRS resource set corresponding to the second SRS group may not be transmitted.

Further, an SRS request field may be received and differently interpreted based on the third information.

Further, the SRS may be transmitted after a specific time from a reception time of the third information.

Further, the third information may be included in DCI or a medium access control control element (MAC CE).

An apparatus for transmitting an SRS in a wireless communication system according to the disclosure may include at least one processor, and at least one memory operably connected to the at least one processor and storing instructions which when executed, cause the at least one processor to perform operations. The operations may include receiving (i) first information related to a plurality of SRS resource sets and (ii) second information related to an SRS group corresponding to each of the plurality of SRS resource sets, wherein each of the plurality of SRS resource sets includes at least one SRS resource, receiving third information indicating that a first SRS group is available and a second SRS group is not available among the SRS groups, and transmitting an SRS in an SRS resource of an SRS resource set included in the first SRS group. All of at least one first SRS resource set included in the first SRS group may correspond to a first number of antenna ports, and all of at least one second SRS resource set included in the second SRS group may correspond to a second number of antenna ports. The first number of antenna ports and the second number of antenna ports may be different.

A computer-readable storage medium according to the disclosure may include at least one computer program causing at least one processor to perform operations. The operations may include receiving (i) first information related to a plurality of SRS resource sets and (ii) second information related to an SRS group corresponding to each of the plurality of SRS resource sets, wherein each of the plurality of SRS resource sets includes at least one SRS resource, receiving third information indicating that a first SRS group is available and a second SRS group is not available among the SRS groups, and transmitting an SRS in an SRS resource of an SRS resource set included in the first SRS group. All of at least one first SRS resource set included in the first SRS group may correspond to a first number of antenna ports, and all of at least one second SRS resource set included in the second SRS group may correspond to a second number of antenna ports. The first number of antenna ports and the second number of antenna ports may be different.

A method of receiving an SRS by a BS in a wireless communication system according to an embodiment of the disclosure may include transmitting (i) first information related to a plurality of SRS resource sets and (ii) second information related to an SRS group corresponding to each of the plurality of SRS resource sets, wherein each of the plurality of SRS resource sets includes at least one SRS resource, transmitting third information indicating that a first SRS group is available and a second SRS group is not available among the SRS groups, and receiving an SRS in an SRS resource of an SRS resource set included in the first SRS group. All of at least one first SRS resource set included in the first SRS group may correspond to a first number of antenna ports, and all of at least one second SRS resource set included in the second SRS group may correspond to a second number of antenna ports. The first number of antenna ports and the second number of antenna ports may be different.

A BS for receiving an SRS in a wireless communication system according to the disclosure may include at least one transceiver, at least one processor, and at least one memory operably connected to the at least one processor and storing instructions which when executed, cause the at least one processor to perform operations. The operations may include transmitting (i) first information related to a plurality of SRS resource sets and (ii) second information related to an SRS group corresponding to each of the plurality of SRS resource sets through the at least one transceiver, wherein each of the plurality of SRS resource sets includes at least one SRS resource, transmitting third information indicating that a first SRS group is available and a second SRS group is not available among the SRS groups through the at least one transceiver, and receiving an SRS in an SRS resource of an SRS resource set included in the first SRS group through the at least one transceiver. All of at least one first SRS resource set included in the first SRS group may correspond to a first number of antenna ports, and all of at least one second SRS resource set included in the second SRS group may correspond to a second number of antenna ports. The first number of antenna ports and the second number of antenna ports may be different.

### Advantageous Effects

According to the disclosure, power consumption of a base station (BS) may be reduced by providing a mechanism in which the BS dynamically turns on/off at least one antenna port in consideration of communication states with associated user equipments (UEs) and a data amount

It will be appreciated by persons skilled in the art that the effects that can be achieved with the disclosure are not limited to what has been particularly described hereinabove and other advantages of the disclosure will be more clearly understood from the following detailed description taken in conjunction with the accompanying drawings.

### BRIEF DESCRIPTION OF THE DRAWINGS

FIG. 1 is a diagram illustrating network energy saving.

FIG. 2 is a diagram illustrating analog beamforming in an NR system;

FIGS. 3 and 4 are diagrams illustrating a sounding reference signal applicable to the disclosure.

FIGS. 5 to 7 are diagrams illustrating an overall operation process of a user equipment (UE) and a base station (BS) according to an embodiment of the disclosure.

FIG. 8 illustrates an exemplary communication system applied to the disclosure.

FIG. 9 illustrates an exemplary wireless device applicable to the disclosure.

FIG. 10 illustrates an exemplary vehicle or autonomous driving vehicle applicable to the disclosure.

### DETAILED DESCRIPTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3^{rd} generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

While the following description is given in the context of a 3GPP communication system (e.g., NR) for clarity, the technical spirit of the disclosure is not limited to the 3GPP communication system. For the background art, terms, and abbreviations used in the disclosure, refer to the technical specifications published before the disclosure (e.g., 38.211, 38.212, 38.213, 38.214, 38.300, 38.331, and so on).

5G communication involving a new radio access technology (NR) system will be described below.

Three key requirement areas of 5G are (1) enhanced mobile broadband (eMBB), (2) massive machine type communication (mMTC), and (3) ultra-reliable and low latency communications (URLLC).

Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is AR for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IOT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases in a 5G communication system including the NR system will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup may be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Finally, logistics and freight tracking are important use cases for mobile communications that enable the tracking of inventory and packages wherever they are by using location-based information systems. The logistics and freight tracking use cases typically require lower data rates but need wide coverage and reliable location information.

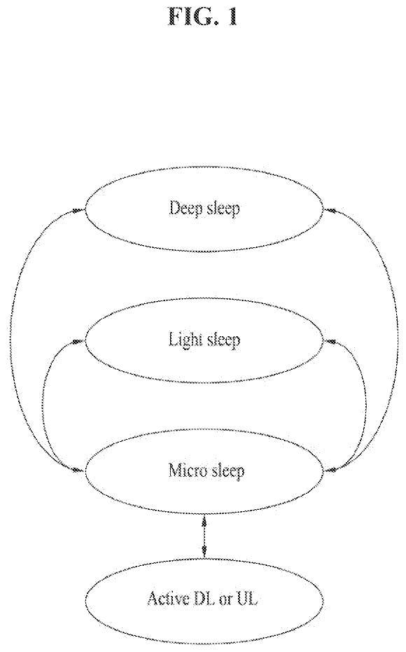

FIG. 1 is a diagram illustrating Network Energy Saving (NES) according to the disclosure.

It has been reported that a New Rat (NR) base station (BS) consumes 3 to 4 times more power than a Long Term Evolution (LTE) BS due to a higher density of installed BSs and use of more antennas/bandwidths/frequency bands in a comparison between the NR system and the LTE system. To solve the problem of the resulting increased operating costs for operators and build an eco-friendly network, a study item was approved to discuss methods of reducing energy consumption of BSs.

In 3GPP RAN WG1, an energy consumption model and simulation methodology for BSs was defined to show that energy consumption gains may be obtained by applying NES technology. Specifically, a sleep state (i.e., a state in which a BS does not perform either of transmission and reception) and an active state (i.e., a state in which the BS performs transmission and/or reception) were defined for BSs, and a transition method for each state was determined, as illustrated in FIG. 1. In addition, a relative power value consumed by a BS in each state, a time and energy required for state transition, and so on were modeled.

The techniques discussed in 3GPP RAN WG1 for NES may be largely classified into four domains (i.e., time/frequency/space/power domains), and the specific techniques for each domain may be summarized as in [Table 1].

TABLE 1
Time domain techniques

| | |
|---|---|
| A-1 | Adaptation of common signals and channels |
| A-2 | Dynamic adaptation of UE specific signals and channels |
| A-3 | Wake up of gNB triggered by UE wake up signal |
| A-4 | Adaptation of DTX/DRX |
| A-5 | Adaptation of SSB/SIB1 |

Frequency domain techniques

| | |
|---|---|
| B-1 | Multi-carrier energy savings enhancements |
| B-2 | Dynamic adaptation of bandwidth part of UE(s) within a carrier |
| B-3 | Dynamic adaptation of bandwidth of active BWP |

Spatial domain techniques

| | |
|---|---|
| C-1 | Dynamic adaptation of spatial elements |
| C-2 | TRP muting/adaptation in multi-TRP operation |

Power domain techniques

| | |
|---|---|
| D-1 | Adaptation of transmission power of signals and channels |
| D-2 | Enhancements to assist gNB digital pre-distortion |
| D-3 | Adaptation of transceiver processing algorithm |
| D-4 | PA backoff adaptation |
| D-5 | UE post-distortion |

As time domain NES techniques, methods have been discussed such as controlling on/off of a UE-common signal (e.g., SSB, SIB, paging, and so on) or a UE-specific signal (e.g., CSI-RS), such as A-1, A-2, and/or A-5 in Table 1, transmitting a wake-up signal to wake up a BS in an inactive state, such as A-3 in Table 1, or controlling transmission and reception of a UE according to a discontinuous transmission/discontinuous reception (DTX/DRX) pattern of a BS, such as A-4 in Table 1.

As frequency domain NES techniques, methods have been discussed such as an SCell operating without a synchronization signal block (SSB) in an inter-band CA situation, such as B-1 in Table 1, and switching a bandwidth part (BWP) or controlling the bandwidth of a BWP, such as B-2 and/or B-3 in Table 1.

As spatial domain NES techniques, methods of supporting per-antenna port on/off or per-transmission and reception point (TRP) on/off in a BS and improving associated CSI measurement and reporting, such as C-1 and/or C-2 in Table 1, have been discussed.

As power domain NES techniques, methods have been discussed such as increasing transmission efficiency by dynamically changing the power of downlink (DL) signals (e.g., SSB, CSI-RS, and PDSCH), such as D-1 in Table 1, or maximizing power amplifier (PA) efficiency by applying digital distortion compensation or tone reservation for a BS/UE, such as D-2, D-3, D-4 and/or D-5 in Table 1.

Apart from for the techniques (e.g., A-4, A-5, and B-1) commonly discussed in 3GPP RAN WG1 and 3GPP RAN WG2, the techniques discussed in 3GPP RAN WG2 for NES include a method of accessing NES-cells by NES-capable UEs or existing NR UEs, an efficient handover method for a UE being connected to an NES-cell, and so on.

As a result of the RAN #98-e meeting, the NES work items were approved and the discussion topics in each leading WG are as follows. The RAN WG1 leading items include methods (e.g., C-1 and D-1) of supporting on/off of BS antenna ports or dynamically changing a power offset between a physical downlink shared channel (PDSCH) and a channel state information-reference signal (CSI-RS), and enhancing CSI measurement and reporting. The RAN WG2 leading items include a method (e.g., A-4) of controlling transmission and reception of UEs according to a DTX/DRX pattern of a BS, a method of preventing existing NR UEs from accessing an NES-cell, and a conditional handover (CHO) method considering a source or target cell that performs an NES operation. In addition, the RAN WG3 leading items include a method of exchanging information about active beams between nodes and paging through a limited area. The RAN WG4 leading items include an SCell operating without an SSB in an inter-band CA situation (e.g., B-1).

In the NR system, a massive multiple input multiple output (MIMO) environment in which the number of transmission/reception (Tx/Rx) antennas is significantly increased may be under consideration. That is, as the massive MIMO environment is considered, the number of Tx/Rx antennas may be increased to a few tens or hundreds. The NR system supports communication in an above 6 GHz band, that is, a millimeter frequency band. However, the millimeter frequency band is characterized by the frequency property that a signal is very rapidly attenuated according to a distance due to the use of too high a frequency band. Therefore, in an NR system operating at or above 6 GHz, beamforming (BF) is considered, in which a signal is transmitted with concentrated energy in a specific direction, not omni-directionally, to compensate for rapid propagation attenuation. Accordingly, there is a need for hybrid BF with analog BF and digital BF in combination according to a position to which a BF weight vector/precoding vector is applied, for the purpose of increased performance, flexible resource allocation, and easiness of frequency-wise beam control in the massive MIMO environment.

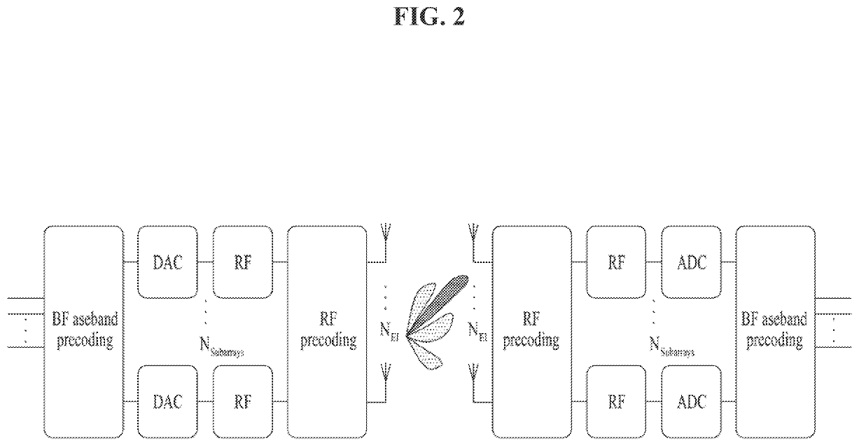

FIG. 2 is a block diagram illustrating an exemplary transmitter and receiver for hybrid BF.

To form a narrow beam in the millimeter frequency band, a BF method is mainly considered, in which a BS or a UE transmits the same signal through multiple antennas by applying appropriate phase differences to the antennas and thus increasing energy only in a specific direction. Such BF methods include digital BF for generating a phase difference for digital baseband signals, analog BF for generating phase differences by using time delays (i.e., cyclic shifts) for modulated analog signals, and hybrid BF with digital BF and analog beamforming in combination. Use of a radio frequency (RF) unit (or transceiver unit (TXRU)) for antenna element to control transmission power and phase control on antenna element basis enables independent BF for each frequency resource. However, installing TXRUs in all of about 100 antenna elements is less feasible in terms of cost. That is, a large number of antennas are required to compensate for rapid propagation attenuation in the millimeter frequency, and digital BF needs as many RF components (e.g., digital-to-analog converters (DACs), mixers, power amplifiers, and linear amplifiers) as the number of antennas. As a consequence, implementation of digital BF in the millimeter frequency band increases the prices of communication devices. Therefore, analog BF or hybrid BF is considered, when a large number of antennas are needed as is the case with the millimeter frequency band. In analog BF, a plurality of antenna elements are mapped to a single TXRU and a beam direction is controlled by an analog phase shifter. Because only one beam direction is generated across a total band in analog BF, frequency-selective BF may not be achieved with analog BF. Hybrid BF is an intermediate form of digital BF and analog BF, using B RF units fewer than Q antenna elements. In hybrid BF, the number of beam directions available for simultaneous transmission is limited to B or less, which depends on how B RF units and Q antenna elements are connected.

### UL BM Procedure

In UL BM, beam reciprocity (or beam correspondence) between Tx and Rx beams may or may not be established according to the implementation of the UE. If the Tx-Rx beam reciprocity is established at both the BS and UE, a UL beam pair may be obtained from a DL beam pair. However, if the Tx-Rx beam reciprocity is established at neither the BS nor UE, a process for determining a UL beam may be required separately from determination of a DL beam pair.

In addition, even when both the BS and UE maintain the beam correspondence, the BS may apply the UL BM procedure to determine a DL Tx beam without requesting the UE to report its preferred beam.

The UL BM may be performed based on beamformed UL sounding reference signal (SRS) transmission. Whether the UL BM is performed on a set of SRS resources may be determined by a usage parameter (RRC parameter). If the usage is determined as BM, only one SRS resource may be transmitted for each of a plurality of SRS resource sets at a given time instant.

The UE may be configured with one or more SRS resource sets (through RRC signaling), where the one or more SRS resource sets are configured by SRS-ResourceSet (RRC parameter). For each SRS resource set, the UE may be configured with K≥1 SRS resources, where K is a natural number, and the maximum value of K is indicated by SRS_capability.

The UL BM procedure may also be divided into Tx beam sweeping at the UE and Rx beam sweeping at the BS similarly to DL BM.

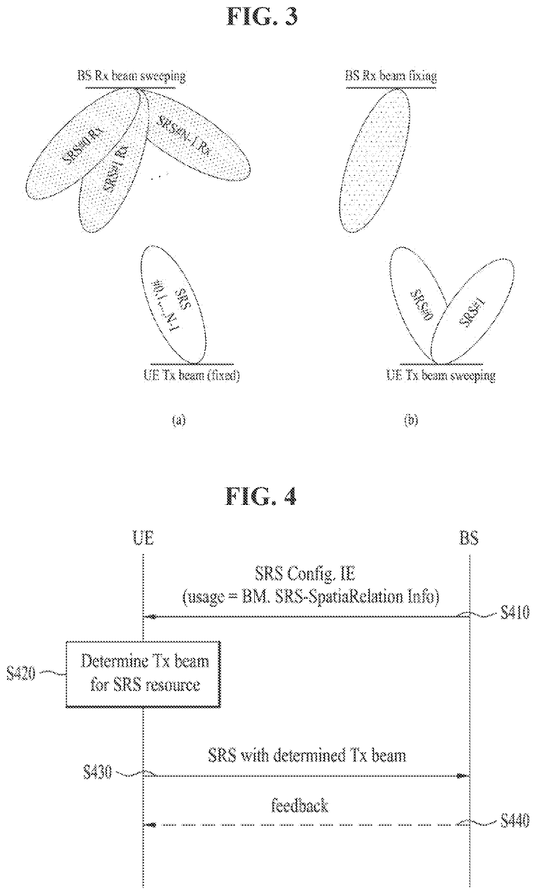

FIG. 3 illustrates an example of a UL BM procedure based on an SRS.

FIG. 3(a) shows a process in which the BS determines Rx beamforming, and FIG. 3(b) shows a process in which the UE performs Tx beam sweeping.

FIG. 4 is a flowchart illustrating an example of a UL BM procedure based on an SRS.
The UE receives RRC signaling (e.g., SRS-Config IE) including a usage parameter (RRC parameter) set to BM from the BS (S410). The SRS-Config IE is used to configure SRS transmission. The SRS-Config IE includes a list of SRS resources and a list of SRS resource sets. Each SRS resource set refers to a set of SRS resources.
The UE determines Tx beamforming for SRS resources to be transmitted based on SRS-SpatialRelation Info included in the SRS-Config IE (S420). Here, the SRS-SpatialRelation Info is configured for each SRS resource and indicates whether the same beamforming as that used for an SSB, a CSI-RS, or an SRS is applied for each SRS resource.
If SRS-SpatialRelationInfo is configured for the SRS resources, the same beamforming as that used in the SSB, CSI-RS, or SRS is applied and transmitted. However, if SRS-SpatialRelationInfo is not configured for the SRS resources, the UE randomly determines the Tx beamforming and transmits an SRS based on the determined Tx beamforming (S430).

For a P-SRS in which ‘SRS-ResourceConfigType’ is set to ‘periodic’:
i) If SRS-SpatialRelationInfo is set to ‘SSB/PBCH’, the UE transmits the corresponding SRS by applying the same spatial domain transmission filter as a spatial domain reception filter used for receiving the SSB/PBCH (or a spatial domain transmission filter generated from the spatial domain reception filter);
ii) If SRS-SpatialRelationInfo is set to ‘CSI-RS’, the UE transmits the SRS by applying the same spatial domain transmission filter as that used for receiving the CSI-RS; or
iii) If SRS-SpatialRelationInfo is set to ‘SRS’, the UE transmits the corresponding SRS by applying the same spatial domain transmission filter as that used for transmitting the SRS.
Additionally, the UE may or may not receive feedback on the SRS from the BS as in the following three cases (S440).
i) When Spatial_Relation_Info is configured for all SRS resources in an SRS resource set, the UE transmits the SRS on a beam indicated by the BS. For example, if Spatial_Relation_Info indicates the same SSB, CRI, or SRI, the UE repeatedly transmits the SRS on the same beam.
ii) Spatial_Relation_Info may not be configured for all SRS resources in the SRS resource set. In this case, the UE may transmit while changing the SRS beamforming randomly.
iii) Spatial_Relation_Info may be configured only for some SRS resources in the SRS resource set. In this case, the UE may transmit the SRS on an indicated beam for the configured SRS resources, but for SRS resources in which Spatial_Relation_Info is not configured, the UE may perform transmission by applying random Tx beamforming.

In proposed methods to be described later, a beam may mean an area for performing a specific operation (e.g., LBT or transmission) by concentrating power in a specific direction and/or in a specific space. In other words, the UE or the BS may perform an operation such as LBT or transmission by targeting a specific area (i.e., a beam) corresponding to a specific space and/or a specific direction. Thus, each beam may correspond to each space and/or each direction. In addition, the UE or the BS may use a spatial domain filter corresponding to each space and/or each direction in order to use each beam. That is, one spatial domain filter may correspond to one or more beams. The UE or the BS may perform an operation such as LBT or transmission using the spatial domain filter corresponding to a beam (or space and/or direction) to be used.

For example, the UE or the BS may perform LBT using a spatial domain filter corresponding to an LBT beam in a space and/or a direction for the corresponding LBT beam or perform DL/UL transmission using a spatial domain filter corresponding to a Tx beam in a space and/or a direction for the corresponding Tx beam.

Regarding antenna ports, an antenna port is defined such that a channel conveying a symbol on the antenna port is inferable from a channel conveying another symbol on the same antenna port. If the large-scale properties of a channel conveying a symbol on one antenna port are inferable from a channel conveying a symbol on another antenna port, it may be said that the two antenna ports are in a quasi co-located or quasi co-location (QC/QCL) relationship. The large-scale properties include one or more of delay spread, Doppler spread, frequency shift, average received power, received timing, average delay, and a spatial Rx parameter. The spatial Rx parameter means a spatial (Rx) channel property parameter such as angle of arrival.

Energy saving of a BS is considered important in wireless communication systems including 3GPP, because it may contribute to building eco-friendly networks by reducing carbon emissions and reducing the operational expenditure (OPEX) of communication industry players. In particular, as the introduction of 5G communication requires high transmission rates, BSs should be equipped with more antennas and provide services in wider bandwidths and frequency bands. As a result, the energy cost of has reached 20% of the total OPEX according to a recent study. Due to this increased interest in BS energy saving, a new study item called “study on network energy savings” was approved in 3GPP NR release 18.

Specifically, the following enhancement techniques are under consideration in order to improve the energy saving capability of a BS from the perspective of transmission and reception.
How to more efficiently apply one or more NES techniques in the time, frequency, spatial, and power domains based on UE assistance information and potential support/feedback from a UE, for a dynamic and/or semi-static operation and a finer granularity adaptation operation in transmission and reception-

Particularly, the disclosure proposes a spatial domain BS energy saving method for an uplink (UL) signal.

The disclosure mainly considers a scenario in which a BS obtains an NES gain by reducing the number of Rx antennas. For example, when a specific Rx antenna port of a BS is turned on or off semi-statically or dynamically, the BS may instruct a UE to turn on or off a UL signal/channel that the BS receives through the Rx antenna port and/or some Tx antenna ports of the UL signal/channel. Accordingly, the power consumption of the BS and the UE may be reduced, and an interference mitigation effect may also be expected.

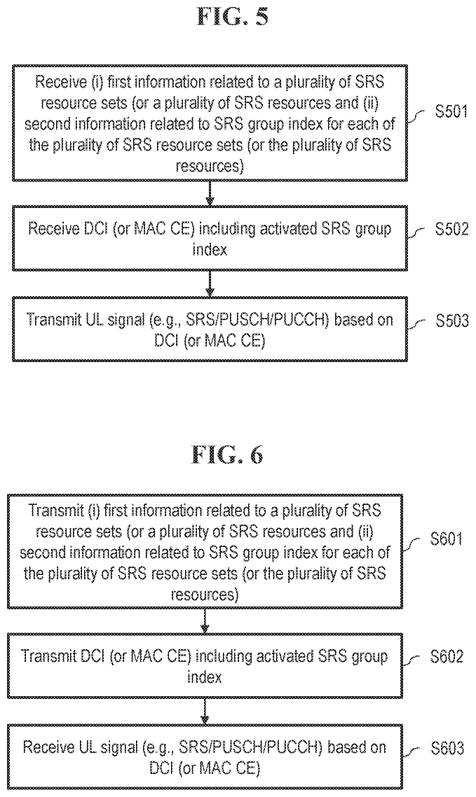

FIGS. 5 to 7 are diagrams illustrating an overall operation process of a UE and a BS according to the disclosure.

FIG. 5 illustrates an overall operation process of a UE according to the disclosure.

Referring to FIG. 5, the UE may receive first information related to a plurality of SRS resource sets or a plurality of SRS resources and second information related to an SRS group index for each of the plurality of SRS resource sets or each of the plurality of SRS resources (S501). Each SRS group index may be associated with a different number of antenna ports. For example, an SRS resource set or SRS resource included in SRS group index #0 may be associated with N1 antenna ports, and an SRS resource set or SRS resource included in SRS group index #1 may be associated with N2 antenna ports.

The UE may receive downlink control information (DCI) and/or a medium access control control element (MAC CE) that activates at least one of configured SRS group indexes (S503). For example, the UE may receive DCI that activates at least one SRS group index through a group common-physical downlink control channel (GC-PDCCH).

The UE may transmit a UL signal based on the received DCI and/or MAC CE (S505). For example, the UE may transmit an SRS, physical uplink shared channel (PUSCH) and/or physical uplink control channel (PUCCH) based on the received DCI and/or MAC CE. In addition, for example, if the UE receives the DCI through the GC-PDCCH, DCI for scheduling the SRS, PUSCH, and/or PUCCH may be received separately. For example, if the UE receives the DCI in a user search space (USS) set instead of the GC-PDCCH, the SRS group index and scheduling information for the SRS, PUSCH, and/or PUCCH may be included together in the DCI. Further, for example, the UE may separately receive the DCI for indicating the SRS group index and the DCI for scheduling the SRS, PUSCH and/or PUCCH.

A specific operation method of the UE according to FIG. 5 may be based on at least one of [Method #1] to [Method #3].

FIG. 6 illustrates an overall operation process of a BS according to the disclosure.

Referring to FIG. 6, the BS may transmit first information related to a plurality of SRS resource sets or a plurality of SRS resources and second information related to an SRS group index for each of the plurality of SRS resource sets or each of the plurality of SRS resources (S601). Each SRS group index may be associated with a different number of antenna ports. For example, an SRS resource set or SRS resource included in SRS group index #0 may be associated with N1 antenna ports, and an SRS resource set or SRS resource included in SRS group index #1 may be associated with N2 antenna ports.

The BS may transmit DCI and/or a MAC CE that activates at least one of configured SRS group indexes (S603). For example, the BS may transmit DCI that activates at least one SRS group index through a GC-PDCCH.

The BS may receive a UL signal based on the transmitted DCI and/or MAC CE (S705). For example, the BS may receive an SRS, PUSCH, and/or PUCCH based on the transmitted DCI and/or MAC CE. In addition, for example, if the BS transmits the DCI through the GC-PDCCH, the BS may transmit DCI for scheduling the SRS, PUSCH, and/or PUCCH separately. For example, if the BS transmits the DCI in a USS set instead of the GC-PDCCH, the SRS group index and scheduling information for the SRS, PUSCH, and/or PUCCH may be included together in the DCI. Further, for example, the BS may separately transmit the DCI for indicating the SRS group index and the DCI for scheduling the SRS, PUSCH, and/or PUCCH.

A specific operation method of the BS according to FIG. 6 may be based on at least one of [Method #1] to [Method #3].

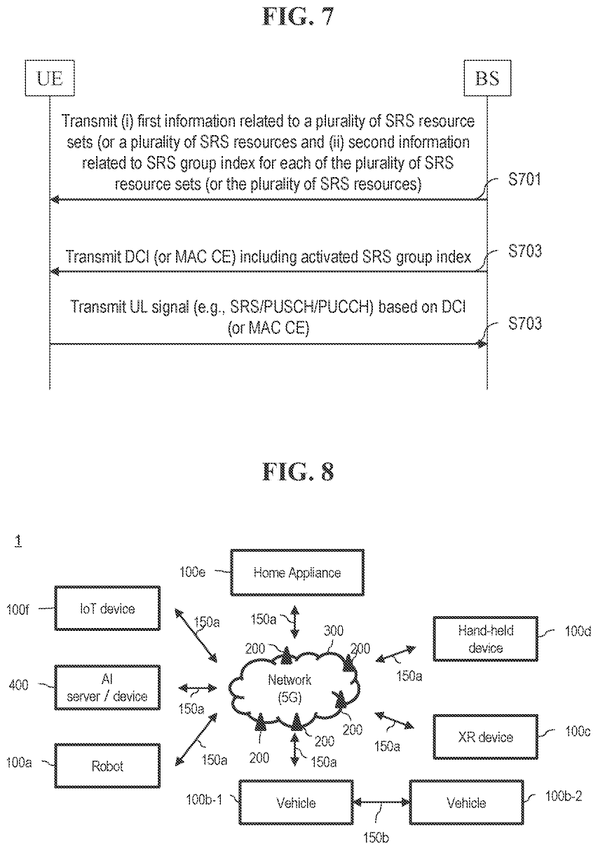

FIG. 7 illustrates an overall operation process of a network according to the disclosure.

Referring to FIG. 7, a BS may transmit, to a UE, first information related to a plurality of SRS resource sets or a plurality of SRS resources and second information related to an SRS group index for each of the plurality of SRS resource sets or the plurality of SRS resources (S701). Each SRS group index may be associated with a different number of antenna ports. For example, an SRS resource set or SRS resource included in SRS group index #0 may be associated with N1 antenna ports, and an SRS resource set or SRS resource included in SRS group index #1 may be associated with N2 antenna ports.

The BS may transmit DCI and/or a MAC CE that activates at least one of configured SRS group indexes to the BS (S703). For example, the BS may transmit DCI that activates at least one SRS group index through a GC-PDCCH.

The BS may receive a UL signal from the UE based on the received DCI and/or MAC CE (S705). For example, the BS may receive an SRS, PUSCH, and/or PUCCH from the UE based on the transmitted DCI and/or MAC CE. In addition, for example, if the BS transmits the DCI through the GC-PDCCH, the BS may transmit DCI for scheduling the SRS, PUSCH, and/or PUCCH separately to the UE. For example, if the BS transmits the DCI in a USS set instead of the GC-PDCCH, the SRS group index and scheduling information for the SRS, PUSCH, and/or PUCCH may be included together in the DCI. Further, for example, the BS may transmit the DCI for indicating the SRS group index and the DCI for scheduling the SRS, PUSCH and/or PUCCH separately to the UE.

Specific operation methods of the BS and the UE according to FIG. 7 may be based on at least one of [Method #1] to [Method #3].

### [Method #1] Method of Reducing Power Consumption of a BS and a UE by Grouping SRS Resources or SRS Resource Sets and Turning on Only an SRS Included in a Specific SRS Group and Turning Off SRSs Included in the Remaining SRS Groups

In one method, a plurality of SRS resource sets and an SRS group index corresponding to each of the SRS resource sets may be configured for the UE. For example, SRS group index #0 corresponding to SRS resource set #1 may be configured, and SRS group index #1 corresponding to SRS resource set #2 may be configured for the UE. The BS may indicate switching between SRS groups by signaling such as DCI or a MAC CE. For example, the BS may transmit an indication to turn off SRS group #0 and turn on SRS group #1 through DCI or a MAC CE.

Upon receipt of the indication, the UE may not transmit at least one SRS resource linked to SRS resource set #1 corresponding to SRS group index #0 or a PUSCH and/or PUCCH linked to the SRS resource or SRS resource set. Alternatively, the UE may not receive DCI that schedules a PUSCH and/or PUCCH transmission linked to the SRS resource or SRS resource set.

Further, upon receipt of the indication, the UE may transmit at least one SRS resource linked to SRS resource set #2 corresponding to SRS group index #1 or a PUSCH and/or PUCCH linked to the corresponding SRS resource or SRS resource set. Alternatively, the UE may receive DCI that schedules a PUSCH and/or PUCCH transmission linked to the SRS resource or SRS resource set.

The number (=N1) of antenna ports for the at least one SRS resource linked to SRS resource set #1 corresponding to SRS group index #0 and the number (=N2) of antenna ports for the at least one SRS resource linked to SRS resource set #2 corresponding to SRS group index #1 may be different. For example, if N1>N2, the BS may reduce power consumption by instructing to turn off SRS group #0 and turn on SRS group #1 and thus performing no reception through some antenna ports.

Although it has been described above that each SRS groups corresponds to one SRS resource set, for convenience description, the disclosure is not limited thereto. For example, each of SRS group #0 and/or SRS group #1 may correspond to a plurality of SRS resource sets. In this case, upon receipt of DCI that indicates to turn on SRS group index #0, the UE may transmit at least one SRS resource linked to the plurality of SRS resource sets included in SRS group #0 or a PUSCH and/or PUCCH linked to the SRS resource set. In addition, the UE may turn on all antenna ports linked to each of the plurality of SRS resource sets included in SRS group #0.

As an additional impact of turn-on of a specific SRS resource set, an SRS resource indicator (SRI) indication/configuration of a configured granted-PUSCH (CG-PUSCH), the interpretation of an SRS request field in aperiodic SRS triggering, and/or the interpretation of a PUCCH resource indicator (PRI) field indicating PUCCH resources may also be changed.

For example, in the case of a type-1 CG-PUSCH which is a CG-PUSCH configured only by an RRC message without activation/release through DCI, the UE may recognize that a plurality of SRIs and/or transmit precoder matrix indicators (TPMIs) with different numbers of antenna ports are linked to SRS resource sets, respectively, and an SRI/or TPMI linked to an actually activated SRS resource set is applied.

In another example, in the case of a type-2 CG PUSCH for which a plurality of CG-PUSCH resources are configured by RRC and a specific CG-PUSCH resource is activated/deactivated by DCI, a different interpretation method may be configured for an SRI or TPMI field of activation DCI on a per-SRS resource set basis, and the UE may interpret the SRI or TPMI field according to an actually activated SRS resource set.

In another example, the interpretation of each code point corresponding to the SRS request field (e.g., bit value of the SRS request field) may be preconfigured to be different for each SRS resource set, and the UE may interpret the SRS request field according to an actually activated SRS resource set.

In another example, the interpretation of each code point corresponding to the PRI field (e.g., bit value of the PRI field) may be preconfigured to be different for each SRS resource set. This is because a different spatial domain filter may be applied for a PUCCH transmission according to an activated SRS resource set. Further, the UE may interpret the PRI field according to an actually activated SRS resource set.

In another method, an SRS group index corresponding to at least one SRS resource included in one SRS resource set may be configured. This method may be applied differently depending on whether a transmission scheme configured for the UE is codebook-based transmission or non-codebook-based transmission.

Codebook-based transmission means a transmission scheme in which a parameter txConfig included in PUSCH-Config is set to ‘codebook’, and is referred to as CB-based UL. In addition, non-codebook-based transmission means a transmission scheme in which the parameter txConfig included in PUSCH-Config is set to ‘nonCodebook’, and is referred to as NCB-based UL.
In CB-based UL, at least one SRS resource may be configured in one SRS resource set, and an SRS group index corresponding to each SRS resource may be configured separately from the SRS resource set including the at least one SRS resource. For example, SRS group index #0 corresponding to SRS resources #1/2 may be configured, and SRS group index #1 corresponding to SRS resource #3 may be configured. The BS may indicate switching between SRS groups by signaling such as DCI or a MAC CE. For example, the BS may transmit an indication to turn off SRS group #0 and turn on SRS group #1 by DCI or a MAC CE.

Upon receipt of the indication, the UE may not transmit SRS resources #½ corresponding to SRS group index #0 or may not transmit a PUSCH and/or PUCCH linked to the SRS resources. Alternatively, the UE may not receive DCI scheduling a PUSCH and/or PUCCH transmission linked to SRS resources #1/2.

Further, upon receipt of the indication, the UE may transmit SRS resource #3 corresponding to SRS group index #1 or may transmit a PUSCH and/or PUCCH linked to the resource. Alternatively, the UE may receive DCI scheduling a PUSCH and/or PUCCH transmission linked to SRS resource #3.

Specifically, the UE may recognize that one of SRS resources corresponding to a turned-on SRS group is indicated by an SRI field of a UL grant, and interpret a Precoding information and number of layers field differently according to the number of antenna ports for the SRS resource corresponding to the turned-on SRS group. In consideration of mismatch between the UE and the BS with respect to a DCI payload size according to an activated SRS group index, the bitwidth of a field with a bit size, which may differ depending on an SRS resource configuration (e.g., the number of antenna ports), such as the SRI and the Precoding information and number of layers, may be configured according the maximum value of the two SRS group indexes. For example, since the number of bits required for SRS group index #0 is 1 and the number of bits required for SRS group index #1 is 0 in the above example, the number of bits of the SRI may be finally determined to be the maximum value, 1 bit.

For example, when the number of antenna ports for at least one SRS resource corresponding to SRS group index #0 is 4 and the number of antenna ports for at least one SRS resource corresponding to SRS group index #1 is 2, upon receipt of an indication indicating turn-on of SRS group index #0, the UE may identify which SRS resource of SRS resource #1 and SRS resource #2 is indicated by the 1 bit of the SRI, and identify an indication in the Precoding information and number of layers field, assuming 4 antenna ports.

On the contrary, upon receipt of an indication indicating turn-on of SRS group index #1, the UE may ignore the 1 bit of the SRI or process it as a reserved bit, and identify that SRS resource #3 is indicated. This is because the number of SRS resources corresponding to SRS group index #1 is 1.

Further, the UE may identify an indication in the Precoding information and number of layers field, assuming 2 antenna ports. When a required number of bits is less than the number of bits allocated to the Precoding information and number of layers field, the UE may interpret the Precoding information and number of layers field through as many least significant bit(s) (LSB(s)) as the required number of bits, assuming that as many most significant bits (MSBs) as the difference are padded with zeroes.

As described above, the BS may perform no reception through some antenna ports by indicating to turn off SRS group #0 and turn on SRS group #1, thereby reducing power consumption.
In NCB-based UL, the number of bits in the SRI field is determined by

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉$$

where L_max represents a maximum number of PUSCH layers supported by the UE in a serving cell, and N_srs represents the number of SRS resources included in an SRS resource configured for NCB-based UL. The value of L_max and/or N_srs may be adjusted by signaling such as DCI or a MAC CE.

The BS may perform no PUSCH reception through some antenna ports by adjusting the number of PUSCH layers, thereby reducing power consumption. For example, the BS may preconfigure two candidate values, L_max,1 and L_max,2 and indicate one of the two candidate values. In consideration of mismatch between the UE and the BS with respect to a DCI payload size according to an actually indicated L_max value, the bitwidth of the SRI field may be set to the maximum value of the numbers of bits required for L_max,1 and L_max,2. For example, when the number of bits required for L_max,1 is 3 and the number of bits required for L_max,2 is 4, the number of bits in the SRI field may be finally determined to be the maximum value of the number of bits required for L_max,1 and the number of bits required for L_max,2, which is 4 bits.

For the indicated L_max value, when a required number of bits is less than the number of bits allocated to the SRI field, the UE may interpret the Precoding information and number of layers field through the LSB(s) corresponding to the required number of bits, assuming that as many MSBs as the difference are padded with zeroes. Similarly to L_max, the BS may preconfigure a plurality of candidate values for N_srs and indicate an actually applicable value, and similarly to CB-based UL, the BS may configure an SRS group index for each SRS resource included in an SRS resource set for NCB-based UL, and indicate switching between SRS groups by signaling such as DCI or a MAC CE. For example, the BS may instruct to turn off SRS group #0 and turn on SRS group #1. For example, SRS group index #0 corresponding to SRS resources #1/2 may be configured, and SRS group index #1 corresponding to SRS resource #3 may be configured. When the BS indicates switching between SRS groups by signaling such as DCI or a MAC CE (e.g., instructs to turn off SRS group #0 and turn on SRS group #1), upon receipt of the indication, the UE may recognize that at least one SRS resource of the turned-on SRS group is indicated by the SRI field of a UL grant.

The bitwidth of the SRI field may be set to the maximum value of the two SRS group indexes. For example, the bitwidth may be set according to the index of the SRS group with the larger number of at least one SRS resource out of the two SRS group indexes. When 4 SRS resources are included in SRS group index #0 and 2 SRS resources are included in SRS group index #1, the bitwidth of the SRI field may be 2 bits.

Specifically, in NCB-based UL, an associated NZP CSI-RS resource may be configured for assisting precoder calculation of the UE. When the number of antenna ports for the NZP CSI-RS resource is changed from N1 to N2, the value of N_srs may also be changed accordingly (e.g., from N1 to N2). Alternatively, when the value of N_srs is changed, some of the antenna ports for the associated NZP CSI-RS resource may be turned on or off accordingly. Alternatively, when an associated NZP CSI-RS resource may be configured separately for each of a plurality of N_srs values, and a specific N_srs value is activated (by DCI or a MAC CE), an associated NZP CSI-RS resource corresponding to the N_srs value may be applied. Alternatively, when an associated NZP CSI-RS resource may be configured separately for each of a plurality of N_srs values, and a specific NZP CSI-RS resource is activated (by DCI or a MAC CE), a specific N_srs value corresponding to the associated NZP CSI-RS resource may be applied.

When the number of antenna ports for an activated SRS resource is 1 in CB-based UL, or the number of SRS resources included in an activated SRS resource set is 1 in NCB-based UL, the need to indicate a DM-RS port index associated with a specific PTRS by a ‘DMRS-PTRS association’ field in a UL grant may be reduced, compared to when another SRS group with a plurality of antenna ports is activated. In this case, the ‘DMRS-PTRS association’ field may be ignored, processed as reserved bits, or assumed to be in a specific state (e.g., all zeroes).

A similar method may be applied to an SRS resource set configured for antenna switching. The BS may configure an SRS resource set corresponding to a specific combination of Tx and Rx antenna numbers, based on Tx and Rx antenna number combinations (e.g., 1T2R and 1T4R) supported by the UE.

In consideration of an energy saving mode operation of the BS, a plurality of SRS resource sets for antenna switching may be configured, and one of the plurality of SRS resource sets may be activated by signaling such as DCI or a MAC CE. For example, the BS may instruct the UE to transmit an SRS for antenna switching by preconfiguring SRS resource set #1 corresponding to 1T4R and SRS resource set #2 corresponding to 2T4R, and activating one of SRS resource set #1 and SRS resource set #2 by signaling such as DCI or a MAC CE.

In the above methods, DCI or a MAC CE indicating switching between SRS groups or a specific parameter value may be transmitted UE-specifically, UE group-commonly, or cell-specifically. In the case of the DCI, it may be transmitted scrambled with a UE-specifically, UE group-commonly, or cell-specifically configured RNTI. In the case of the MAC CE, it may be transmitted through a PDSCH scheduled by DCI scrambled with a UE-specifically, UE group-commonly, or cell-specifically configured RNTI, and the PDSCH may also be scrambled with a UE-specifically, UE group-commonly, or cell-specifically configured RNTI.

A carrier/serving cell carrying the DCI or MAC CE may be different from a carrier/serving cell in which antenna switching is performed or to which the indicated specific parameter value is applied, and antenna switching between SRS groups or a specific parameter value for a plurality of carriers/serving cells may be indicated by the DCI or MAC CE. For example, common antenna switching between SRS groups or a common specific parameter value may be indicated for a plurality of carriers/serving cells, or different antenna switching between SRS groups or a different specific parameter value may be indicated for each carrier/serving cell.

For example, antenna switching for second and third carriers and antenna switching for a first carrier may be indicated together by DCI or a MAC CE received in the first carrier. Further, in the above case, the DCI or MAC CE may indicate common application of one antenna switching indication to the first to third carriers, or may individually indicate an antenna switching indication for each of the first to third carriers.

Further, the UE may perform an indicated antenna switching operation after a predetermined time of an application delay from reception of DCI or a MAC CE indicating antenna switching between SRS groups or a specific parameter value. For example, the UE may perform the indicated antenna switching operation from a time point that is after K1 symbols/slots/msec after a reception time of the DCI or MAC CE, where K1 is predefined/preconfigured or reported by UE capability signaling, or from a slot or slot-group boundary closest to the time point that is K1 symbols/slots/msec after the transmission time of the reception time of the DCI or MAC CE.

In another example, the UE may perform the indicated antenna switching operation from a time point that is K1 symbols/slots/msec after a transmission time of an HARQ-ACK feedback corresponding to the received DCI or MAC CE, where K1 is predefined/preconfigured or reported by UE capability signaling, or from a slot or slot-group boundary closest to the time point that is K1 symbols/slots/msec after the transmission time of the HARQ-ACK feedback corresponding to the received DCI or MAC CE.

A timer value for an antenna switching operation may be preset/predefined. When the UE starts a timer from a reception time of an indication to turn on SRS group index n (e.g., n=1) and turn off SRS group index m (e.g., m=0) or from a time when it performs antenna switching, and then the timer value expires, the UE may perform an operation of turning off SRS group index n and turning on SRS group index m, even if it does not receive an antenna switching indication by DCI or a MAC CE.

When an SRS resource set or SRS resource corresponding to specific SRS group index k is not configured, upon receipt of an indication to turn on SRS group index k by DCI or a MAC CE, the UE may not transmit an SRS or a UL signal/channel for a specific time period or until an indication to turn on another SRS group index is received.

The above method may be linked to a DRX configuration. For example, in the case where an SRS resource, an SRS resource set, an SRS group index, or a specific parameter value is configured for each DRX under a plurality of DRX configurations (e.g., DRX configuration #1 and DRX configuration #2), and then a specific DRX configuration is activated, the UE may perform the above-described operations when a linked SRS resource or SRS resource set is activated or a linked specific parameter value is indicated. For example, when DRX configuration #1 is activated, an SRS resource set or SRS resource linked to DRX configuration #1 may be considered to be activated, and antenna ports corresponding to the SRS resource set may be turned on, as in the above-described method. In the case where DRX configuration #1 is activated, when an SRS resource set or SRS resource linked to DRX configuration #2 is indicated to be activated, the UE may ignore this indication or suspend it until DRX configuration #2 is activated.

Alternatively, even for one DRX configuration, a configuration for an SRS resource, an SRS resource set, an SRS group index, or a specific parameter value may also be applied depending on whether it is a DRX active time (e.g., a time period during which an on Durationtimer and/or inacitivitytimer is running, or a time during which the UE should be awake for transmission and/or reception). That is, in the DRX active time, the UE may perform the above predetermined operations when the linked SRS resource or SRS resource set is activated or the linked specific variable value is indicated. For example, within the DRX active time, the UE may consider the SRS resource set or SRS resource linked to the DRX active time to be activated, and thus turn on antenna ports corresponding to the SRS resource set as in the above method. Conversely, outside the DRX active time, the UE may consider an SRS resource set or SRS resource linked to a corresponding DRX inactive time to be activated, and thus turn on antenna ports corresponding to the SRS resource set as in the above method.

In turning on and off a specific SRS resource or SRS resource set as in the above proposed method, a channel state information-reference signal (CSI-RS) resource or a CSI-RS resource set may also be linked. For example, an SRS resource or SRS resource set and a CSI-RS resource or CSI-RS resource set may be linked to each SS group index, and when a specific SRS group index is turned on or off, an SRS resource or SRS resource set and a CSI-RS resource or CSI-RS resource set for which the SRS group index has been configured or which are associated with the SRS group index may be turned on or off at once. Being associated may mean that an association has been preconfigured/predefined separately, a QCL source-target relationship has been established, or an RS for spatial relation information has been configured.

### [Method #2] Method of Reducing Power Consumption of a BS by Using a Deactivation and Activation Mechanism

In the current NR system, for a semi-persistent (SP) SRS or SP positioning SRS, deactivation or activation of one SRS resource set may be indicated by one MAC CE. For example, deactivating an SRS resource set linked to at least one SRS resource configured with N1 antenna ports and activating an SRS resource set linked to at least one SRS resource configured with other N2 (<N1) antenna ports may be useful in terms of BS power saving.

However, the current mechanism may be inefficient because it requires transmitting a MAC CE for deactivation and a MAC CE for activation to deactivate N1 antenna ports and activate N2 antenna ports, respectively. Therefore, the disclosure proposes a more efficient deactivation/activation mechanism.

At least one of the following methods is applied to an SP SRS or SP positioning SRS, so that SRS resource set index #n may be deactivated and another SRS resource set index #m may be activated by one DCI or MAC CE.
SRS resource set index #n and SRS resource set index #m may be individually indicated by separate fields in the DCI or MAC CE. For example, when SRS resource set index #n is indicated in field #1 (e.g., MCS) and SRS resource set index #m is indicated in field #2 in the DCI, the UE may consider that SRS resource set index #n is deactivated and SRS resource set index #m is activated.
Linkage between SRS resource set index #n and SRS resource set index #m may be preconfigured, so that when one is activated or deactivated, the other one may be configured to be automatically deactivated or activated. For example, when deactivation is indicated for SRS resource set index #n by DCI or a MAC CE, the UE may consider that SRS resource set index #m is automatically activated.

In another example, when activation is indicated for SRS resource set index #n by DCI or a MAC CE, the UE may consider that SRS resource set index #m, which has been already activated (and/or is being activated), is automatically deactivated. The linkage may be extended to one-to-many, many-to-one, or many-to-many mapping, not just one-to-one mapping. For example, in the case of many-to-many mapping, linkage between SRS resource set indexes #n1, #n2, and #n3 and SRS resource set indexes #m1, #m2, and #m3 may be preconfigured. When one of SRS resource set indexes #n1, #n2, and #n3 is activated or deactivated, the UE may consider that the corresponding SRS resource set index #m1, #m2, or #m3 may be automatically deactivated.
For one of a plurality of code points corresponding to one field in DCI or a MAC CE, at least one SRS resource set to be activated and at least one SRS resource set to be deactivated may be configured. For example, when SRS resource set index #n to be activated and SRS resource set index #m to be deactivated are preconfigured for a specific code point of a CSI request field in DCI and the code-point is indicated, the UE may consider that SRS resource set index #n is deactivated and SRS resource set index #m is activated.
For specific SRS resource set index #n, it may be configured that when a corresponding SRS resource set is activated or deactivated, all other SRS resource sets that have been activated (and/or are being activated) are automatically deactivated or activated. For example, when activation is indicated for SRS resource set index #n by DCI or a MAC CE, the UE may assume that all other SRS resource sets that have been activated (and/or are being activated) are automatically deactivated.
A separate 1-bit flag in DCI or a MAC CE may indicate whether to apply the existing activation/deactivation operation or the proposed new operation.
In the above proposed methods, an SRS resource set may be replaced with an SRS resource. In this case, when there is at least one SRS resource with a different number of antenna ports in one SRS resource set, as in the structure proposed in [Method #1], an operation of turning on and off only an SRS resource corresponding to a specific number of antenna ports among the at least one SRS resource may also be considered.

In the above methods, DCI or a MAC CE indicating activation and/or deactivation may be transmitted UE-specifically, UE group-commonly, or cell-specifically. In the case of the DCI, it may be transmitted scrambled with a UE-specifically, UE group-commonly, or cell-specifically configured RNTI. In the case of the MAC CE, it may be transmitted through a PDSCH scheduled by DCI scrambled with a UE-specifically, UE group-commonly, or cell-specifically configured RNTI, and the PDSCH may also be scrambled with a UE-specifically, UE group-commonly, or cell-specifically configured RNTI.

A carrier/serving cell carrying the DCI or MAC CE may be different from a carrier/serving cell in which antenna switching is performed or to which the indicated specific parameter value is applied, and activation and/or deactivation for a plurality of carriers/serving cells may be indicated by the DCI or MAC CE. For example, common activation and/or deactivation may be indicated for a plurality of carriers/serving cells, or different activation and/or deactivation may be indicated for each carrier/serving cell.

For example, activation and/or deactivation for second and third carriers and activation and/or deactivation for a first carrier may be indicated together by DCI or a MAC CE received in the first carrier. Further, in the above case, the DCI or MAC CE may indicate common application of one activation and/or deactivation indication to the first to third carriers, or may individually indicate an activation and/or deactivation indication for each of the first to third carriers.

According to the existing NR operation for the SP SRS, when BWP switching is performed from BWP #1 to BWP #2, an SP SRS reporting configuration activated in BWP #1 may be suspended, and when the UE switches back from BWP #n (n is an integer other than 1) to BWP #1, the suspended SP SRS configuration may be automatically activated without an additional activation process.

(If the UE has an active semi-persistent SRS resource configuration and has not received a deactivation command, the semi-persistent SRS configuration is considered to be active in the UL BWP which is active, otherwise it is considered suspended.)

However, from the perspective of power saving of the BS, it may not be desirable for the BS to operate a corresponding Rx antenna to activate and support the suspended SP SRS simultaneously with switching to BWP #1. Therefore, the BS may configure whether to suspend or deactivate an active SP SRS transmission during BWP switching. For example, when switching back to the linked BWP, the BS may configure whether the SP SRS transmission is automatically activated without an additional activation mechanism or re-enabled only when there is an additional activation mechanism (e.g., indicating activation of the SP SRS transmission by DCI and/or a MAC CE) in spite of switching back to the linked BWP.

Alternatively, when NES mode-on is configured/indicated or a specific DRX configuration is applied for a serving cell, the UE may consider an already active SP SRS transmission to be deactivated during BWP switching. For example, the UE may consider the SP SRS transmission to be re-enabled only when there is an additional activation mechanism, such as indicating activation of the SP SRS transmission by DCI and/or a MAC CE, even if it is switched back to a linked BWP.

The above method may be linked to a DRX configuration. For example, in the case where an SP SRS to be activated is configured for each DRX under a plurality of DRX configurations (e.g., DRX configuration #1 and DRX configuration #2), and then a specific DRX configuration is activated, the UE may activate only an SP SRS transmission linked to the DRX configuration and deactivate the other already active SP SRS transmissions.

Alternatively, even for one DRX configuration, a different activation and/or deactivation operation may also be applied depending on whether it is a DRX active time (e.g., a time period during which an onDurationtimer and/or inacitivitytimer is running, or a time during which the UE should be awake for transmission and/or reception).

That is, in the DRX active time, the UE may activate only a linked SP SRS transmission and deactivate the other already active SP SRS transmissions.

In activating/deactivating a specific SRS resource or SRS resource set as in the above proposed method, a CSI-RS resource or a CSI-RS resource set may also be linked. For example, an SRS resource or SRS resource set and a CSI-RS resource or CSI-RS resource set may be linked, and when a specific SRS resource or SRS resource set is activated or deactivated, the BS may activate/deactivate an indicated or associated CSI-RS resource or CSI-RS resource at once. Being associated may mean that an association has been preconfigured/predefined separately, a QCL source-target relationship has been established, or an RS for spatial relation information has been configured.

[Method #3] Method of Reducing Power Consumption in Receiving a UL Signal/Channel at a BS by Signaling an on/Off Indicator for an Antenna Port and/or Panel and/or TRP and/or Pol of a UE

In the above [Method #1] or [Method #2], the number of Rx antenna ports of a BS and the number of Tx antenna ports of a UE may be adjusted by per-SRS resource on/off or per-SRS resource set on/off, thereby controlling the power consumption of the BS and the UE.

In [Method #3], a method is proposed to save energy of a BS and a UE by controlling on/off of some of N1 antenna ports for an SRS resource or SRS resource set configured with the N1 antenna ports.

Specifically, at least one of the following indication methods may be indicated by DCI and/or a MAC CE. In the following methods, an antenna port may be replaced with a panel (for transmission of a UE and/or reception of a BS).

In addition to signaling described below, a timer/duration and/or a time-domain pattern indicator may be configured/indicated by DCI and/or a MAC CE (or preconfigured/predefined) to indicate how long the indication will be applied. For example, it may be indicated that transmission and reception are performed using fewer antenna ports than N1 by applying the indication during T2 slots that is T1 slots after a reference time point such as an HARQ-ACK corresponding to a DCI reception or a MAC CE, and then all N1 antenna ports are used for transmission and reception. Further, for example, it may be indicated that transmission and reception are performed using fewer antenna ports than N1 by applying the indication during T2 slots, all N1 antenna ports are used for transmission and reception during T3 slots, and the T2/T3 slot pattern is repeated. In another example, all N1 antenna ports may be used for transmission and reception in even-indexed slots, and fewer antenna ports than N1 may be used for transmission and reception in odd-indexed slots.

Now, a description will be given of a method of indicating on/off some of N1 antenna ports.
On/off of each antenna port or antenna port group may be indicated by a bitmap. For example, on/off of each antenna port may be controlled by an N1-bit bitmap. In another example, considering signaling overhead, on/off of antenna ports may be controlled by an N2 (<N1)-bit bitmap, and the index of an antenna port linked to each bit may be preset or determined by a rule. For example, when N2-2, a first bit may be a bit for turning on/off even-indexed antenna ports, and a second bit may be a bit for turning on/off odd-indexed antenna ports. Alternatively, the first bit may a bit for turning on/off antenna ports as many as or fewer than {N1/2}, and the second bit may be a bit for turning on/off the other antenna ports.
On/off of antenna ports may be indicated by an N3-bit field, and for each of 2\hat{ }(N3) code points, the index of an antenna port to be turned on or off may be preconfigured. For N3=1, when ‘0’ is signaled, it may mean that all N1 antenna ports are turned on, and when ‘l’ is signaled, it may mean that preconfigured antenna ports or antenna ports as many as or fewer than {N1/2} among of the N1 antenna ports are turned on.

In the above methods, when it is said that specific antenna ports are turned on (assuming that the number of turned-on antenna ports is X1), this may mean that the UE allocates power only to the antenna ports indicated to be turned on, when transmitting a corresponding SRS resource. Alternatively, it may mean that when a PUSCH is scheduled for the UE by a UL grant, an interpretation method for the SRI field or the Precoding information and number of layers field is changed.

For example, in the case of CB-based UL, the interpretation of the Precoding information and number of layers field may vary depending on the value of X1. For example, according to the TS 38.212 specification, in the case where ul-FullPowerTransmission is not set, maxRank is set to 1, and codebookSubset is set to ‘partialAndNonCoherent’, when the number of antenna ports is 4/2/1, the number of bits in the corresponding field may be 5/4/0, respectively. When candidate values for X1 are {4,2,1}, the bitwidth of the corresponding field is fixed to 5 bits, which is the maximum value of required numbers of bits. In this state, when X1=4, information about a TPMI may be received in 5 bits, when X1=2, information about a TPMI is received in 4 LSBs or MSBs, and when X1=1, the corresponding field may be ignored or considered as reserved bits.

Alternatively, in another method, in the case where antenna ports are indexed with 0/1/2/3 for X1=4, when a specific antenna port is turned off, the UE may expect a TPMI for which the turned-off antenna port is used not to be indicated, or if indicated, ignore the corresponding UL grant. For example, when antenna ports with the indexes 0/1/2 are turned off, a TPMI that the UE considers to be valid may be

$$\frac{1}{2} [ \begin{matrix}0 \\ 0 \\ 0 \\ 1\end{matrix} ]$$

only.

In the case of NCB-based UL, the number of bits in the SRI field is determined by

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉$$

where L_max represents a maximum number of layers of a PUSCH supported by the UE in a corresponding serving cell, and N_srs represents the number of SRS resources included in an SRS resource set configured for NCB-based UL. When the number of Tx antenna ports of the UE may be adjusted by signaling such as DCI or a MAC CE, the N_srs value may be adjusted accordingly. Through this, the BS may adjust the number of layers of a PUSCH and thus perform no reception through some antenna ports, thereby reducing power consumption. N_srs may be replaced with X1. In this case, the bitwidth of the SRI field may be set to the maximum of required numbers of bits for possible X1 values. For example, if the candidate values for X1 are {4,2,1}, when the bitwidths of the SRI field corresponding to the respective candidate values are {a, b, c}, the bitwidth of the SRI field may be finally determined as the maximum value of {a, b, c}, as described above.

A type-1 CG-PUSCH is a CG-PUSCH configured only by an RRC message without activation/release through DCI. In the case of the type-1 CG-PUSCH, the UE may recognize that a plurality of SRIs or a plurality of TPMIs are linked to different numbers of antenna ports, and an SRI or TPMI corresponding to X1 antenna ports is applied. Further, in the case of a type-2 CG PUSCH for which a plurality of CG-PUSCH resources are configured by RRC and a specific CG-PUSCH resource is activated/released through DCI, the UE may recognize that a different interpretation method may be preconfigured for each X1 for the SRI/or TPMI field of activation DCI, and an SRI or TPMI corresponding to an actually indicated X1 value is applied.

Interpretation of each code point corresponding to the SRS request field is preconfigured to be different for each X1 value, and the UE may interpret the SRS request field according to an actually indicated X1 value. Similarly, interpretation of each code point corresponding to the PRI field may be preconfigured to be different for each X1 value, and the UE may interpret the PRI field according to an actually indicated X1 value. This is because a different spatial domain filter may be applied to a PUCCH transmission according to an activated SRS resource set.

A similar method may be applied to an SRS resource set configured for antenna switching. The BS may configure an SRS resource set corresponding to a specific combination of Tx and Rx antenna numbers, based on Tx and Rx antenna number combinations (e.g., 1T2R and 1T4R) supported by the UE.

In consideration of an energy saving mode operation of the BS, a plurality of SRS resource sets for the purpose of antenna switching may be configured, and one of the plurality of SRS resource sets may be activated by an indicated X1 value. For example, the BS may instruct the UE to transmit an SRS for the purpose of antenna switching by preconfiguring SRS resource set #1 corresponding to 1T4R and SRS resource set #2 corresponding to 2T4R, and activating SRS resource set #1 when X1=1 is indicated by signaling such as DCI or a MAC CE or activating SRS resource set #2 when X1=2 is indicated by signaling such as DCI or a MAC CE.

When a plurality of TRPs are configured for a UL transmission of the UE, the on/off state of each TRP may be indicated by DCI and/or a MAC CE. Similarly to the above methods, on/off of each TRP or TRP group may be indicated by bitmap information, or the on/off state of each TRP may be indicated by each code point of a field. When off is indicated for a specific TRP, at least one of the following operations may be applied.
When a turned-off TRP is indicated by an ‘SRS resource set indicator’ field, the UE may ignore the corresponding UL grant, process the corresponding field as reserved, or assume a specific state (e.g., ‘00’) for the corresponding field.
A ‘Second SRS resource indicator’ field and/or a ‘Second Precoding information’ field may be processed as reserved or assumed to be in a specific state (e.g., all zeros) by the UE.

In another method, the on/off state of each pol in a cross-polarization antenna structure may be indicated by DCI and/or a MAC CE. Similarly to the above methods, on/off of each pol (i.e., /direction pol or \ direction pol) may be indicated by bitmap information, or the on/off state of each pol may be indicated by each code point of a field. The UE may transmit only at least one SRS resource for which antenna ports linked to turned-on pols are turned on and a UL signal/channel corresponding to the at least one SRS resource.

In the above methods, an on/off indicator for antenna ports and/or panels and/or TRPs and/or pols of the UE may be transmitted UE-specifically, UE group-commonly, or cell-specifically by DCI or a MAC CE signaled by the BS. In the case of the DCI, it may be transmitted scrambled with a UE-specifically, UE group-commonly, or cell-specifically configured RNTI. In the case of the MAC CE, it may be transmitted through a PDSCH scheduled by DCI scrambled with a UE-specifically, UE group-commonly, or cell-specifically configured RNTI, and the PDSCH may also be scrambled with a UE-specifically, UE group-commonly, or cell-specifically configured RNTI.

A carrier/serving cell carrying the DCI or MAC CE may be different from a carrier/serving cell in which an on/off operation is performed for antenna ports and/or panels and/or TRPs and/or pols of the UE, and the on/off operation may be indicated for antenna ports and/or panels and/or TRPs and/or pols in a plurality of carriers/serving cells by the DCI or MAC CE.

For example, a common on/off operation for antenna ports and/or panels and/or TRPs and/or pols may be indicated for a plurality of carriers/serving cells, or a different on/off operation for antenna ports and/or panels and/or TRPs and/or pols may be indicated for each carrier/serving cell.

For example, an on/off operation for antenna ports and/or panels and/or TRPs and/or pols in a first carrier may be indicated together with an on/off operation for antenna ports and/or panels and/or TRPs and/or pols in second and third carriers by DCI or a MAC CE received in the first carrier. Further, in the above case, the DCI or MAC CE may indicate common application of one on/off operation for antenna ports and/or panels and/or TRPs and/or pols to the first to third carriers, or may individually indicate an on/off operation for antenna ports and/or panels and/or TRPs and/or pols for each of the first to third carriers.

The above method may be linked to a DRX configuration. For example, in the case where an antenna port and/or panel and/or TRP and/or pol is configured for each DRX under a plurality of DRX configurations (e.g., DRX configuration #1 and DRX configuration #2), and then a specific DRX configuration is activated, the UE may perform a UL signal/channel transmission according to an on/off configuration for an antenna port and/or panel and/or TRP and/or pol linked to the DRX configuration.

Alternatively, even for one DRX configuration, a configuration for an antenna port and/or panel and/or TRP and/or pol to be turned on/off may also be applied depending on whether it is a DRX active time (e.g., a time period during which an onDurationtimer and/or inacitivitytimer is running, or a time during which the UE should be awake for transmission and/or reception). That is, in the DRX active time, the UE may perform a UL signal/channel transmission according to a linked on/off configuration for an antenna port and/or panel and/or TRP and/or pol.

In turning on and off an antenna port and/or panel and/or TRP and/or pol for a specific SRS resource as in the above proposed method, a CSI-RS resource may also be linked. For example, an SRS resource or SRS resource set and a CSI-RS resource or CSI-RS resource set may be linked, and when an antenna port and/or panel and/or TRP and/or pol for a specific SRS resource or SRS resource set is turned on or off, an antenna port and/or panel and/or TRP and/or pol corresponding to an indicated or associated CSI-RS resource or CSI-RS resource set may be also be turned on or off. Being associated may mean that an association has been preconfigured/predefined separately, a QCL source-target relationship has been established, or an RS for spatial relation information has been configured, and a correspondence relationship between antenna ports and/or panels and/or TRPs and/or poles may also be preconfigured/predefined.

According to [Method #1] to [Method #3], the power consumption of the BS may be adjusted by adjusting the number of antenna ports used for SRS or PUSCH/PUCCH transmission and reception. That is, power used for SRS or PUSCH/PUCCH transmission and reception may be reduced as a whole by turning on only a required number of antenna ports.

The various descriptions, functions, procedures, proposals, methods, and/or operation flowcharts of the present disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

FIG. 8 illustrates a communication system 1 applied to the present disclosure.

Referring to FIG. 8, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smartpad, a wearable device (e.g., a smartwatch or smartglasses), and a computer (e.g., a laptop). The home appliance may include a TV, a refrigerator, a washing machine, and so on. The IoT device may include a sensor, a smartmeter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g. V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g. relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

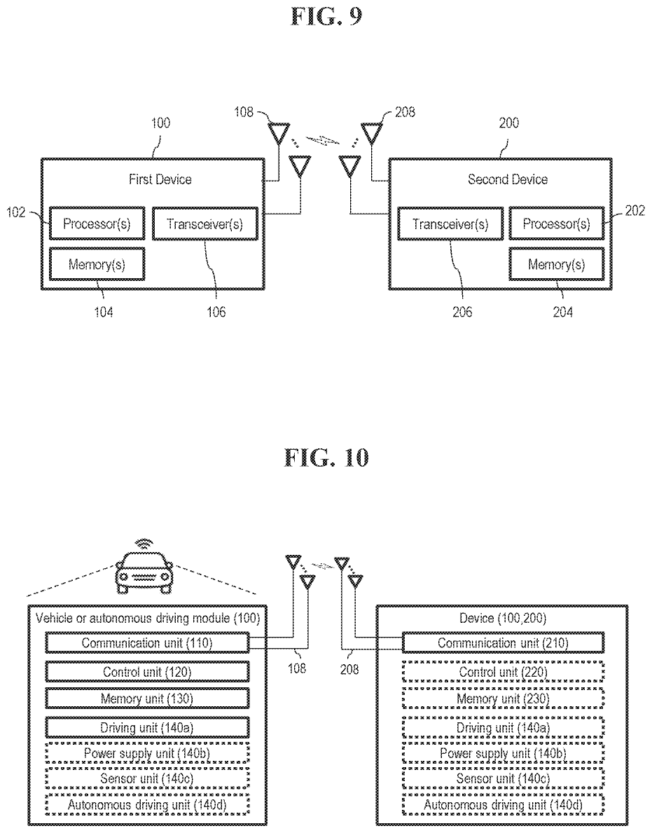

FIG. 9 illustrates wireless devices applicable to the present disclosure.

Referring to FIG. 9, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 8.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

Specifically, instructions and/or operations, controlled by the processor 102 of the first wireless device 100 and stored in the memory 104 of the first wireless device 100, according to an embodiment of the present disclosure will be described.

Although the following operations will be described based on a control operation of the processor 102 in terms of the processor 102, software code for performing such an operation may be stored in the memory 104. For example, in the present disclosure, the at least one memory 104 may be a computer-readable storage medium and may store instructions or programs. The instructions or programs may cause, when executed, the at least one processor operably connected to the at least one memory to perform operations according to embodiments or implementations of the present disclosure, related to the following operations.

For example, the processor 102 may control the transceiver 206 to receive first information related to a plurality of SRS resource sets or a plurality of SRS resources and second information related to an SRS group index for each of the plurality of SRS resource sets or each of the plurality of SRS resources. Each SRS group index may be associated with a different number of antenna ports. For example, an SRS resource set or SRS resource included in SRS group index #0 may be associated with N1 antenna ports, and an SRS resource set or SRS resource included in SRS group index #1 may be associated with N2 antenna ports.

The processor 102 may control the transceiver 106 to receive DCI and/or a MAC CE that activates at least one of configured SRS group indexes. For example, the processor 102 may receive DCI activating at least one group index through a GC-PDCCH.

The processor 102 may control the transceiver 106 to transmit a UL signal based on the received DCI and/or MAC CE. For example, the processor 102 may control the transceiver 106 to transmit an SRS, PUSCH, and/or PUCCH based on the received DCI and/or MAC CE.

Further, for example, when the processor 102 receives the DCI through the GC-PDCCH, the processor 102 may control the transceiver 106 to separately receive the DCI for scheduling the SRS, PUSCH, and/or PUCCH. When the processor 102 receives the DCI in a USS set of a PDCCH other than the GC-PDCCH, the SRS group index and scheduling information for the SRS, PUSCH, and/or PUCCH may be included together in the DCI. Further, for example, the processor 102 may control the transceiver 106 to separately receive the DCI indicating the SRS group index and the DCI for scheduling the SRS, PUSCH, and/or PUCCH.

The specific operation method of the processor 102 may be based on at least one of [Method #1] to [Method #3].

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Specifically, instructions and/or operations, controlled by the processor 202 of the second wireless device 100 and stored in the memory 204 of the second wireless device 200, according to an embodiment of the present disclosure will be described.

Although the following operations will be described based on a control operation of the processor 202 in terms of the processor 202, software code for performing such an operation may be stored in the memory 204. For example, in the present disclosure, the at least one memory 204 may be a computer-readable storage medium and may store instructions or programs. The instructions or programs may cause, when executed, the at least one processor operably connected to the at least one memory to perform operations according to embodiments or implementations of the present disclosure, related to the following operations.

For example, the processor 202 may control the transceiver 206 to transmit first information related to a plurality of SRS resource sets or a plurality of SRS resources and second information related to an SRS group index for each of the plurality of SRS resource sets or each of the plurality of SRS resources. Each SRS group index may be associated with a different number of antenna ports. For example, an SRS resource set or SRS resource included in SRS group index #0 may be associated with N1 antenna ports, and an SRS resource set or SRS resource included in SRS group index #1 may be associated with N2 antenna ports.

The processor 202 may control the transceiver 206 to transmit DCI and/or a MAC CE that activates at least one of configured SRS group indexes. For example, the processor 202 may control the transceiver 206 to transmit DCI activating at least one group index through a GC-PDCCH.

The processor 202 may control the transceiver 206 to receive a UL signal based on the transmitted DCI and/or MAC CE. For example, the processor 202 may control the transceiver 206 to receive an SRS, PUSCH, and/or PUCCH based on the transmitted DCI and/or MAC CE. Further, for example, when the processor 202 transmits the DCI through the GC-PDCCH, the processor 202 may control the transceiver 206 to separately transmit the DCI for scheduling the SRS, PUSCH, and/or PUCCH. When the processor 202 transmits the DCI in a USS set of a PDCCH other than the GC-PDCCH, the SRS group index and scheduling information for the SRS, PUSCH, and/or PUCCH may be included together in the DCI. Further, for example, the processor 202 may control the transceiver 206 to separately receive the DCI indicating the SRS group index and the DCI for scheduling the SRS, PUSCH, and/or PUCCH.

The specific operation method of the processor 202 may be based on at least one of [Method #1] to [Method #3].

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

FIG. 10 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 10, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

The embodiments of the present disclosure described herein below are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It will be obvious to those skilled in the art that claims that are not explicitly cited in each other in the appended claims may be presented in combination as an embodiment of the present disclosure or included as a new claim by a subsequent amendment after the application is filed.

In the present disclosure, a specific operation described as performed by the BS may be performed by an upper node of the BS in some cases. Namely, it is apparent that, in a network comprised of a plurality of network nodes including a BS, various operations performed for communication with an MS may be performed by the BS, or network nodes other than the BS. The term ‘BS’ may be replaced with the term ‘fixed station’, ‘Node B’, ‘enhanced Node B (eNode B or eNB)’, ‘access point’, etc.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

While the above-described method of transmitting and receiving uplink signals and the apparatus therefor have been described based on an example applied to a 5G NR system, the method and apparatus are applicable to various wireless communication systems in addition to the 5G NR system.

1. A method of transmitting a sounding reference signal (SRS) by a user equipment (UE) in a wireless communication system, the method comprising:
receiving (i) first information related to a plurality of SRS resource sets and (ii) second information related to an SRS group corresponding to each of the plurality of SRS resource sets, wherein each of the plurality of SRS resource sets includes at least one SRS resource;
receiving third information informing that a first SRS group is available and a second SRS group is not available among the SRS groups; and
transmitting an SRS in an SRS resource of an SRS resource set included in the first SRS group,
wherein all of at least one first SRS resource set included in the first SRS group corresponds to a first number of antenna ports, and all of at least one second SRS resource set included in the second SRS group corresponds to a second number of antenna ports, and
wherein the first number of antenna ports and the second number of antenna ports are different.

2. The method according to claim 1, wherein the SRS is not transmitted in an SRS resource of an SRS resource set corresponding to a second SRS group.

3. The method according to claim 1, wherein a first physical uplink shared channel (PUSCH) or a first physical uplink control channel (PUCCH) associated with an SRS resource set corresponding to the first SRS group is transmitted, and a second PUSCH or a second PUCCH associated with an SRS resource set corresponding to the second SRS group is not transmitted.

4. The method according to claim 1, wherein an SRS request field is received, and differently interpreted based on the third information.

5. The method according to claim 1, wherein the SRS is transmitted after a specific time from a reception time of the third information.

6. The method according to claim 1, wherein the third information is included in downlink control information (DCI) or a medium access control control element (MAC CE).

7. A user equipment (UE) for transmitting a sounding reference signal (SRS) in a wireless communication system, the UE comprising:
at least one transceiver;
at least one processor; and
at least one memory operably connected to the at least one processor and storing instructions which when executed, cause the at least one processor to perform operations,
wherein the operations include:
receiving (i) first information related to a plurality of SRS resource sets and (ii) second information related to an SRS group corresponding to each of the plurality of SRS resource sets through the at least one transceiver, wherein each of the plurality of SRS resource sets includes at least one SRS resource;
receiving third information informing that a first SRS group is available and a second SRS group is not available among the SRS groups through the at least one transceiver; and
transmitting an SRS in an SRS resource of an SRS resource set included in the first SRS group through the at least one transceiver,
wherein all of at least one first SRS resource set included in the first SRS group corresponds to a first number of antenna ports, and all of at least one second SRS resource set included in the second SRS group corresponds to a second number of antenna ports, and
wherein the first number of antenna ports and the second number of antenna ports are different.

8. The UE according to claim 7, wherein the SRS is not transmitted in an SRS resource of an SRS resource set corresponding to a second SRS group.

9. The UE according to claim 7, wherein a first physical uplink shared channel (PUSCH) or a first physical uplink control channel (PUCCH) associated with an SRS resource set corresponding to the first SRS group is transmitted, and a second PUSCH or a second PUCCH associated with an SRS resource set corresponding to the second SRS group is not transmitted.

10. The UE according to claim 7, wherein an SRS request field is received, and differently interpreted based on the third information.

11. The UE according to claim 7, wherein the SRS is transmitted after a specific time from a reception time of the third information.

12. The UE according to claim 7, wherein the third information is included in downlink control information (DCI) or a medium access control control element (MAC CE).

13-15. (canceled)

16. A base station (BS) for receiving a sounding reference signal (SRS) in a wireless communication system, the BS comprising:
at least one transceiver;
at least one processor; and
at least one memory operably connected to the at least one processor and storing instructions which when executed, cause the at least one processor to perform operations,
wherein the operations include:
transmitting (i) first information related to a plurality of SRS resource sets and (ii) second information related to an SRS group corresponding to each of the plurality of SRS resource sets through the at least one transceiver, wherein each of the plurality of SRS resource sets includes at least one SRS resource;
transmitting third information informing that a first SRS group is available and a second SRS group is not available among the SRS groups through the at least one transceiver; and
receiving an SRS in an SRS resource of an SRS resource set included in the first SRS group through the at least one transceiver,
wherein all of at least one first SRS resource set included in the first SRS group corresponds to a first number of antenna ports, and all of at least one second SRS resource set included in the second SRS group corresponds to a second number of antenna ports, and
wherein the first number of antenna ports and the second number of antenna ports are different.
